(19) United States
(12) Patent Application Publication
(10) Pub. No.: US 2006/0021710 A1
(43) Pub. Date: Feb. 2, 2006

(54) Die bonding apparatus

(75) Inventor: Kazunori Nitta, Kyoto-shi (JP)

Correspondence Address: BIRCH STEWART KOLASCH & BIRCH, PO BOX 747, FALLS CHURCH, VA, 22040-0747, US

(73) Assignee: TOWA CORPORATION

(21) Appl. No.: 11/191,067

(22) Filed: Jul. 28, 2005

(30) Foreign Application Priority Data
Jul. 29, 2004 (JP) 2004-221234

(51) Int. Cl. B32B 37/00; B32B 38/04

(52) U.S. Cl. 156/538; 156/510; 156/584

(57) ABSTRACT

A die bonding apparatus includes a pre-press and fix unit and a bonding unit each having an imager and a holder that can move independently and simultaneously. This allows the imager and the holder to simultaneously exhibit their respective functions. Consequently the die bonding apparatus can mount an electronic component on a substrate rapidly and with high precision.

### BACKGROUND OF THE INVENTION

1. Field of the Invention

The present invention relates to die bonding apparatuses mounting an electronic component, such as a semiconductor chip having an integrated circuit or the like formed therein, on a substrate with a die bonding, double sided adhesive tape posed therebetween.

2. Description of Related Art

A conventional die bonding apparatus is used to mount an electronic component on a substrate in a method as described hereinafter. Note that the electronic component is assumed to be a semiconductor chip or the like having an IC or the like formed therein for the sake of illustration.

When the conventional die bonding apparatus is used to mount the electronic component on the substrate, a die bonding adhesive film is initially stuck on the substrate at a prescribed position. This die bonding adhesive film is a double sided adhesive film having main opposite surfaces each with a peel off film thereon. Accordingly, initially with one adhesive surface having the peel off film remaining thereon the other, exposed adhesive surface is stuck on the substrate. One adhesive surface then has its peel off film peeled off. One adhesive surface is thus exposed. Subsequently, the electronic component is stuck on one adhesive surface and thus mounted on the substrate via the double sided adhesive film.

The above described conventional die bonding apparatus includes five units as follows: a pre-press and fix unit, a main press and fix unit, a peel-off unit, a bonding unit, and an after-press unit. The die bonding apparatus performs a die bonding process as will now be described hereinafter more specifically.

Initially, the pre-press and fix unit cuts the die bonding, double sided adhesive tape into a prescribed size to provide a double sided adhesive film, and then removes the peel off film from the other adhesive surface. Note that the pre-press and fix unit has a holder, which then holds and moves the double sided adhesive film and sets it on the substrate at a prescribed position. Note that the double sided adhesive film's one adhesive surface has the pee-off film still remaining thereon.

Then the main press and fix unit employs a presser and fixer to press the double sided adhesive film's other adhesives surface via the peel off film against the substrate to firmly fix the other adhesive surface on the substrate.

Then the peel off unit presses a film peeling adhesive tape (having one side adhesive) against the peel off film remaining on one adhesive surface. The peel off film thus adheres on the adhesive tape. Then together with the adhesive tape the peel off film is removed from the one adhesive surface of the double sided adhesive film. As a result, only the double sided adhesive film having one adhesive surface exposed remains on the substrate.

The bonding unit has a holder, which then holds the electronic component and then moves and sets the electronic component on the double sided adhesive film. The after-press unit then presses the electronic component against the double sided adhesive film and thus mounts the electronic component on the substrate at the prescribed position.

The above described, conventional pre-press and fix unit is provided with a holder 101 and an imager 102, as shown in FIGS. 10-14, moving together.

The pre-press and fix unit initially cuts a die bonding adhesive tape 104 into a required size, as shown in FIG. 10, to provide a piece 103, which is a double sided adhesive film 103a having one adhesive surface with a peel off 103b still remaining thereon. Note that piece 103 is located at a piece forming position 105, and held by holder 101 (a holding step S).

Then, as shown in FIG. 11, with piece 103 held by holder 101, from piece forming position 105 to a prescribed position on substrate 101 holder 101 and imager 102 move together (a moving step T). Then, as shown in FIG. 12, when imager 102 arrives at a position over the prescribed position on substrate 101 imager 102 recognizes the position (a step U). Then, as shown in FIG. 13, after recognition step U holder 101 and imager 102 together move to a position over the prescribed position on substrate 100 (a moving step V).

Then, as shown in FIG. 14, when holder 101 arrives at the position over the prescribed position on substrate 100 holder 101 sets piece 103 on substrate 100 at the prescribed position (a supplying step W).

Thus the conventional pre-press and fix unit performs such five steps (S-W) as shown in FIGS. 10-14 sequentially.

Furthermore, as well as the aforementioned pre-press and fix unit, a conventional bonding unit is also provided with a bonding holder and a bonding imager, although not shown. They move together. As such, the conventional bonding unit is capable of sequentially performing steps similar to the aforementioned five steps (S-W) to mount an electronic component on a substrate at a prescribed position.

In recent years there is a demand for reduced cost for substrate. To meet the demand, a matrix substrate is frequently used. The matrix substrate allows a large number of electronic components to be mounted thereon. Electronic components mounted on the matrix substrate are small in thickness and size. Accordingly, techniques are currently developed to mount a large number of thin and small electronic components on a matrix substrate at a prescribed position rapidly and with high precision.

Mounting a large number of such electronic components on a substrate entails sticking a large number of double sided adhesive films on the substrate. In that case, to enable the pre-press and fix unit to perform the FIGS. 10-14 five steps (S-W) in a reduced period of time, it is necessary that the five steps (S-W) be each performed in a reduced period of time and that any ones of the five steps be performed simultaneously.

However, holder 101 and imager 102 cannot be moved separately, which prevents any ones of five steps from being performed simultaneously. In other words, the conventional die bonding apparatus necessitates performing the five steps (S-W) sequentially. As such, the die bonding apparatus only allows the five steps to be each performed in a reduced period of time. No matter how each step's time is reduced, the five steps' total time cannot be reduced significantly.

For example, when holder 101 performs holding step S, imager 102 cannot perform recognition step U. That is, steps S and U cannot be performed rapidly. In other words, the conventional die bonding apparatus does not have a structure allowing both of the holding and recognition steps to be performed rapidly and with high precision.

### SUMMARY OF THE INVENTION

The present invention contemplates a die bonding apparatus that can perform both a holding step and a recognition step rapidly and with high precision.

The present invention in one aspect provides a die bonding apparatus mounting an electronic component on a substrate at a prescribed position with a double sided adhesive film posed therebetween, and including a pre-press and fix unit, a main press and fix unit, and a bonding unit. The pre-press and fix unit includes a cutter cutting a double sided adhesive tape into a prescribed size, a first imager recognizing the prescribed position on the substrate, and a first holder setting the double sided adhesive film at the prescribed position. The main press and fix unit includes a first presser and fixer pressing the double sided adhesive film against the substrate to fix the double sided adhesive film on the substrate at the prescribed position. The bonding unit includes a second imager recognizing the prescribed position on the substrate, and a second holder setting the electronic component on the double sided adhesive film set on the substrate at the prescribed position. The pre-press and fix unit has the first imager and the first holder adapted to be movable mutually independently and simultaneously and the bonding unit has the second imager and the second holder adapted to be movable mutually independently and simultaneously.

The above configuration allows a pre-pressing and fixing step and a bonding step to be performed rapidly.

Furthermore the present die bonding apparatus moves the substrate through the pre-press and fix unit, followed by the main press and fix unit and then the bonding unit sequentially and continuously.

This allows steps performed by the three units to be performed rapidly.

The present invention in another aspect provides a die bonding apparatus corresponding to that in the above one aspect that further includes a peel off unit and an after-press unit.

More specifically the present die bonding apparatus in the above other aspect includes a pre-press and fix unit, a main press and fix unit, a peel off unit, a bonding unit, and an after-press unit.

The pre-press and fix unit includes a cutter cutting into a prescribed size a double sided adhesive tape having a peel off film adhering thereto, a first imager recognizing the prescribed position on the substrate, and a first holder setting the double sided adhesive film at the prescribed position. The main press and fix unit includes a first presser and fixer pressing the double sided adhesive film against the substrate via the peel off film to fix the double sided adhesive film on the substrate at the prescribed position. The peel off unit includes a peel off film remover applying an adhesive tape on the peel off film and removing the peel off film from the double sided adhesive film to allow the double sided adhesive film alone to remain on the substrate. The bonding unit includes a second imager recognizing the prescribed position on the substrate, and a second holder setting the electronic component on the double sided adhesive film set on the substrate at the prescribed position. The after-press unit includes a second presser and fixer pressing against and fixing on the adhesive film the electronic component located at the prescribed position. The pre-press and fix unit has the first imager and the first holder adapted to be movable mutually independently and simultaneously and the bonding unit has the second imager and the second holder adapted to be movable mutually independently and simultaneously.

The above configuration, as well as the die bonding apparatus in one aspect, allows a pre-pressing and fixing step and a bonding step to be performed rapidly.

In the above other aspect the die bonding apparatus has the pre-press and fix unit, the main press and fix unit, the peel off unit, the bonding unit and the after-press unit integrated together and moves the substrate through the pre-press and fix unit, followed by the main press and fix unit, then the peel off unit, then the bonding unit, and then the after-press unit sequentially and continuously.

This allows steps performed by the five units to be performed rapidly.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a die bonding apparatus in an embodiment.

FIG. 2 shows in steps how an electronic component is stuck on a substrate via double sided adhesive film.

FIGS. 3, 4 and 5 illustrate a pre-pressing and fixing step at first, second and third substeps, respectively.

FIG. 6 illustrates a peel off step.

FIGS. 7, 8 and 9 illustrate a bonding step at first, second and third substeps, respectively.

FIGS. 10, 11, 12, 13 and 14 illustrate holding, moving, recognition, moving and supplying steps, respectively, performed by a conventional die bonding apparatus.

### DESCRIPTION OF THE PREFERRED EMBODIMENTS

Hereinafter, reference will be made to the drawings to describe a die bonding apparatus of the present invention in an embodiment.

The embodiment provides a die bonding apparatus 50 is employed to mount an electronic component on a substrate 1 at a prescribed position 2 via a double sided adhesive film 5. Substrate 1 includes a lead frame. In the present embodiment the electronic component is a semiconductor chip 3 of an IC or the like by way of example.

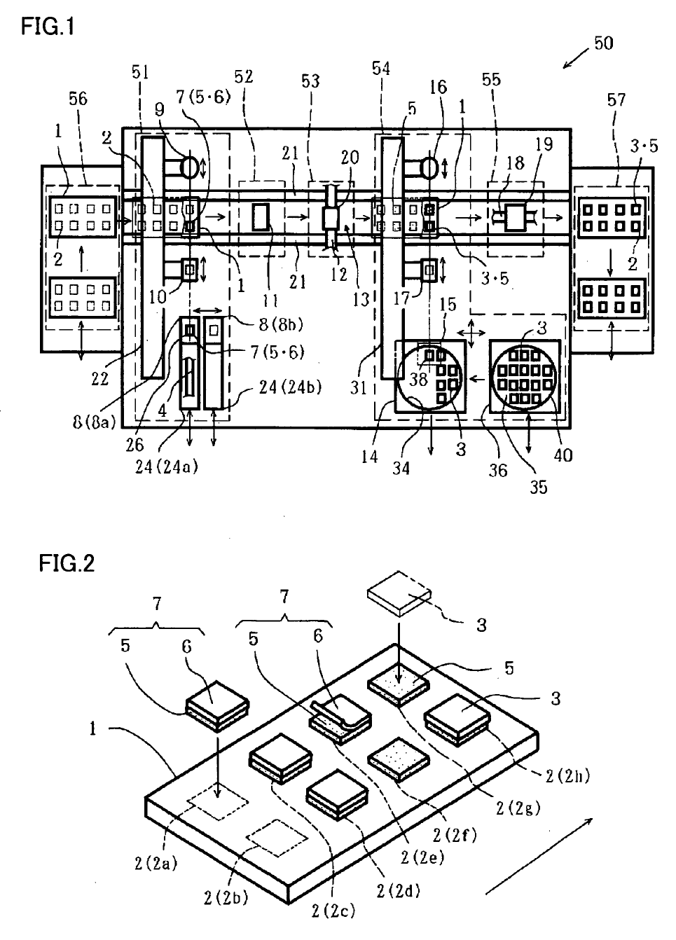

As shown in FIG. 1, die bonding apparatus 50 includes a pre-press and fix unit 51, a main press and fix unit 52, a peel off unit 53, a bonding unit 54, and an after-press unit 55.

Pre-press and fix unit 51 includes a cutter 8, an image 9, and a holder 10. Cutter 8 cuts a die bonding adhesive tape 4 into a required size to provide a piece 7 of double sided adhesive film 5 having peel off film 6 thereon. Imager 9 recognizes a prescribed position 2 on substrate 1. Holder 10 holds and thus moves piece 7 to position 2 and sets piece 7 at position 2.

Main press and fix unit 52 has a presser and fixer 11 pressing piece 7 against substrate 1 at position 2.

Peel off unit 53 includes a peel off film remover 13 causing peel off film 6, serving as a peel off member, to adhere on a peel off film removing adhesive tape 12 at position 2 with piece 7 posed therebetween. After peel off film 6 is removed from piece 7, double sided adhesive film 5 alone remains on substrate 1.

Bonding unit 54 includes a chip projector 15, an imager 16, and a holder 17. A chip projector 15 causes semiconductor chip 3 to individually project from a wafer table 14. Imager 16 recognizes the prescribed position 2 on substrate 1. Holder 17 holds and thus moves semiconductor chip 3 and sets it at position 2 with double sided adhesive film 5 posed therebeetween.

After-pressing unit 55 presses semiconductor chip 3 at position 2 against double sided adhesive film 5 to fix semiconductor chip 3 there, or a chip protection film 18 covers a surface of semiconductor chip 3 and after-press unit 55 presses semiconductor chip 3 against double sided adhesive film 5 via chip protection film 18 and thus fix chip 3 on film 5.

Note that, as described in the present embodiment, adhesive tape 4 that has been cut provides piece 7 formed of the two layers of double sided adhesive film 5 and peel off film 6. Alternatively, the piece may be formed of a single layer of double sided adhesive film 5 alone or three layers implemented by double sided adhesive film 5 having opposite surfaces each with peel off film 6 thereon.

Furthermore, other than the aforementioned five units 51-55, die bonding apparatus 50 has an in-magazine unit 56 and an out-magazine unit 57 as shown in FIG. 1, positioned on left and right hands, respectively.

In-magazine unit 56 houses substrate 1 before piece 7 is stuck thereon, and in a die bonding process in-magazine unit 56 transports substrate 1 to pre-press and fix unit 51. Out-magazine unit 57 houses substrate 1 transported with semiconductor chip 3 mounted thereon.

Furthermore, die bonding apparatus 50 transports substrate 1 from in-magazine unit 56 through units 51, 52, 53, 54 and 55 to out-magazine unit 57 sequentially.

The aforementioned seven units 51-57 are integrated together and arranged to allow substrate 1 to be transported on a path in the form of a straight line. Furthermore, the seven units 51-57 are adapted in die bonding apparatus 50 to be optionally selected, as appropriate, and thus attached/detached.

In-magazine unit 56 and out-magazine unit 57 are different in that the former houses substrate 1 before double sided adhesive film 5 is stuck thereon whereas the latter houses substrate 1 having semiconductor chip 3 mounted thereon. However, the units are both intended to house substrate 1 and accordingly, basically configured of substantially similar components.

In-magazine unit 56 and out-magazine unit 57 are each provided with a magazine cassette in the form of a slit bearing a required plurality of mutually spaced and vertically arranged substrates 1.

In-magazine unit 56 and an out-magazine unit 57 each have a lower portion at which the magazine cassette having substrate 1 housed therein is placed. Substrate 1 is placed in the cassette such that position 2 receiving doubled sided adhesive film 5 and semiconductor chip 3 faces upward. It should be noted, however, that in-magazine unit 56 may employ a magazine cassette in the form for example of a stack allowing a plurality of substrates 1 to be stacked directly.

After pre-press and fix unit 51, main press and fix unit 52, peel off unit 53, bonding unit 54 and after-press unit 55 performs their respective steps, double sided adhesive film 5 is stuck or semiconductor chip 3 is mounted, as shown at prescribed positions 2a-2h.

At positions 2a and 2b is shown substrate 1 before the pre-pressing and fixing step. At position 2b is shown the exact substrate 1's condition. At position 2a is shown substrate 1 immediately before piece 7 is set by holder 10 of pre-press and fix unit 51.

At positions 2c and 2d is shown substrate 1 after the main pressing and fixing step completes, i.e., after piece 7 is pressed by presser and fixer 11 of main press and fix unit 52 against substrate 1 and thus fixed thereon.

At position 2e is shown peel off film 6 being removed from double sided adhesive film 5 by a presser 20 of peel off film remover 13. At position 2f is shown peel off film 6 having completely been removed by peel off film remover 13 and double sided adhesive film 5 alone remaining on substrate 1.

At position 2g is shown substrate 1 after peel off film 6 is removed and immediately before semiconductor chip 3 is set on double sided adhesive film 5 on substrate 1 when semiconductor chip 3 projected by chip projector 15 of bonding unit 54 is set on double sided adhesive film 5 by holder 17 of bonding unit 54.

At position 2h is shown substrate 1 after bonding is completed and semiconductor chip 3 set on substrate 1 is pressed and thus fixed by a presser and fixer 19 of after-press unit 55 with double sided adhesive film 5 posed therebetween.

Die bonding apparatus 50 has two rails 21 substantially in straight line extending rightward and leftward, as shown in FIG. 1, to transport substrate 1.

Rails 21 each have a lateral cross section in the form of a horseshoe having a lateral recess facing to that of the other rail so as to receive either end of substrate 1. Substrate 1 is transported by a chuck (not shown) provided at rails 21. The chuck transports substrate 1 from pre-press and fix unit 51, main press and fix unit 52, peel off unit 53, bonding unit 54 to after-press unit 55 sequentially.

Furthermore, die bonding apparatus 50 can slide each unit 51-57 rightward and leftward as seen in FIG. 1. As such, die bonding apparatus 50 can slide the five units 51-55 in accordance for example with substrate 1's frame length (in the figure, a length in a direction of a longer side) and thus achieve further reduced operation time.

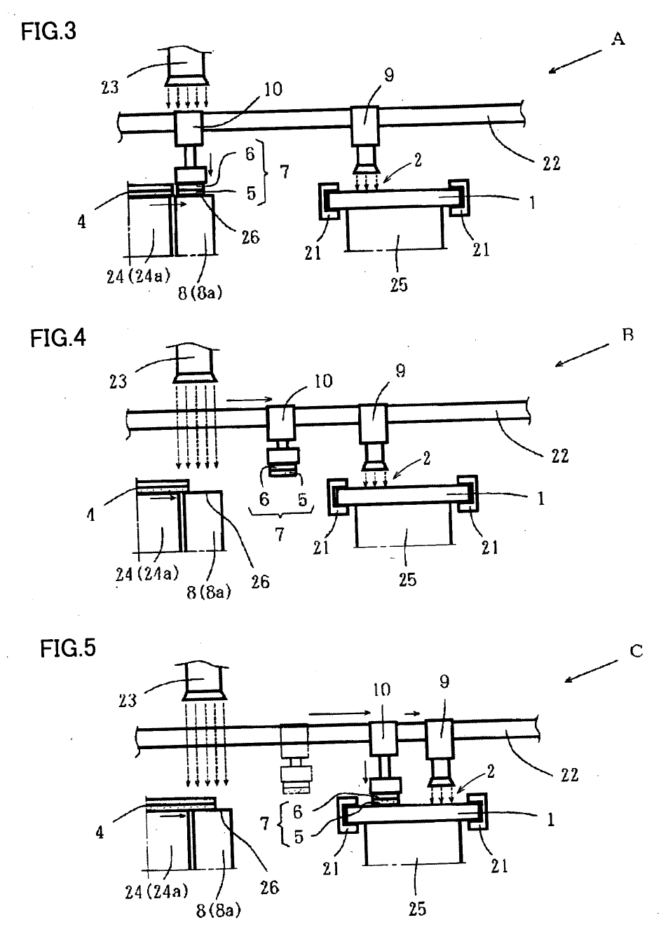

With reference to FIGS. 1-5, pre-press and fix unit 51 will be described more specifically. Note that FIGS. 3-5 illustrate three steps performed by pre-press and fix unit 51 shown in FIG. 1.

As shown in FIGS. 1 and 3-5, pre-press and fix unit 51 is provided with a tape cutter 8, a substrate recognizing imager 9, and a piece holder 10. Pre-press and fix unit 51 is also provided with a rail 22 guiding imager 9 and holder 10, a tape recognizing imager 23, a tape loader 24, and a piece supplying and setting platform 25.

Substrate recognizing imager 9 and piece holder 10 are guided on a single rail 22. Imager 9 and holder 10 can, however, independently move along rail 22. Rails 22 and 21 traverse each other as seen in a plane. Vertically, however, rails 22 and 21 are spaced as prescribed. As such, imager 9 and holder 10 will not collide against rail 21.

Imager 9 and holder 10 are independently and simultaneously used in three steps (steps A, B and C shown in FIGS. 3, 4 and 5, respectively) performed by pre-press and fix unit 51. Accordingly, as shown in FIGS. 3-5, holder 10 reciprocates along rail 22 between a piece forming position 26 bearing a cut and awaiting piece 7 and the prescribed position 2 on substrate 1. Imager 9 reciprocates between position 2 and a position rightward of platform 25. Thus, as has been described above, pre-press and fix unit 51 can have imager 9 and holder 10 independently and simultaneously moved along rail 22.

Tape recognizing imager 23 is provided separately from substrate recognizing imager 9. While imager 9 can move, imager 23 is fixed at a position over piece forming position 26. It should be noted, however, that imager 23 may also be adapted to be movable as well as imager 9.

A cut piece 7 held by holder 10, adhesive tape 4 cut by cutter 8 and loader 24, as will be described hereinafter, and adhesive tape 4 fed, and the like are continuously or intermittently recognized by imager 23, as shown in FIGS. 3-5.

Cutter 8 and loader 24 are configured to be capable of integration, as shown in FIG. 1, and attached to and detached from die bonding apparatus 50.

Furthermore, cutter 8 has two cutters 8a and 8b arranged, as seen in FIG. 1, in rightward and leftward directions in parallel. Cutter 8a has a mechanism in a system of a cutter using a cutter member (not shown) to cut adhesive tape 4 fed by a loader 24a. Cutter 8b has a mechanism in a punching system using a punching member (not shown) to cut only a required portion of adhesive tape 4 fed by a loader 24b. Two cutters 8a and 8b can independently operate.

Loaders 24a and 24b each includes a loading cassette portion (not shown) supplying cutters 8a and 8b, respectively, at piece forming position 26 with adhesive tape 4 and also taking up and housing adhesive tape 4. The loading cassette portion is adapted to allow a variety of adhesive tape 4 to be attached thereto and detached therefrom.

While FIG. 1 shows cutter 8a adopting a cutter system and loader 24a to cut adhesive tape 4 in a required size, alternatively cutter 8b in the punching system and loader 24b may be adopted to cut adhesive tape 4 in a required size depending on substrate 1 and adhesive tape 4.

Furthermore, the cutter system and the punching system can be switched by sliding cutter 8 and loader 24 manually or automatically in rightward and leftward directions. More specifically, cutter 8a and loader 24a, and cutter 8b and loader 24b are adapted to be separately slidable in die bonding apparatus 50. Furthermore, the cutter system and the punching system can simultaneously be employed. Only one of the cutter 8a and loader 24a in the cutter system and the cutter 8b and loader 24b in the punching system may be arranged in die bonding apparatus 50.

Furthermore, a torque clutch is adopted as a mechanism causing loader 24a or 24b to take up a 3-layer adhesive tape 4 before it is supplied to cutter 8a or 8b.

Furthermore, the cutter 8a cutter member (not shown) has one surface processed to be sharp. Alternatively, the cutter member may have opposite surfaces processed to be sharp so that it can efficiently be increased in longevity. Other than this cutter member, a cutter knife blade (not shown) may be adopted that has a reduced cutting area and cutting characteristics unaffected by the characteristic(s) of adhesive tape 4.

If adhesive tape 4 is significantly adhesive, there is an increased possibility that resin configuring adhesive tape 4 adheres to cutter 8, loader 24 and/or the like. To address this, that portion of cutter 8 and loader 24 to which the resin readily adheres may for example have silicone, fluororesin or similar non-adhesive member attached thereto.

Furthermore, as die bonding apparatus 50 has loader 24a or 24b, simply exchanging adhesive tape 4 of loader 24a or 24b allows die bonding apparatus 50 to be available. This can contribute to a reduced operation time of die bonding apparatus 50.

Pre-press and fix unit 51 performs three steps (A-C) as will now be described hereinafter.

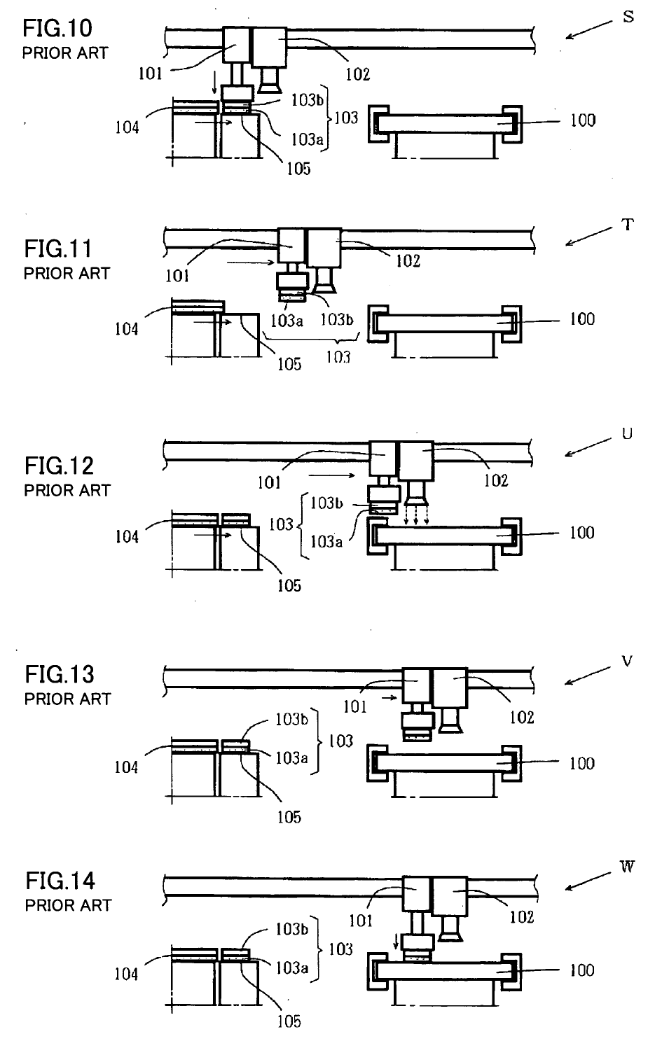

Initially FIG. 3 shows conventional holding step S (see FIG. 10) and recognition step U (see FIG. 12) individually and simultaneously performed by die bonding apparatus 50 of the present embodiment.

As shown in FIG. 3, substrate recognizing imager 9 and piece holder 10 independently and simultaneously perform a holding step and a recognition step. For the sake of convenience, the FIG. 3 step will be referred to as a holding and recognition step A.

Adhesive tape 4, fed by loader 24, is cut at piece forming position 26 by cutter 8 into a required size. Piece 7 is then formed, and held by holder 10. Independently of the holding step performed by holder 10, imager 9 employs a charge coupled device (CCD) camera or the like to recognize the prescribed position 2, while imager 23 implemented for example by a CCD camera monitors how piece 7 is held and cut.

FIG. 4 shows the three steps of conventional moving steps T and V (see FIGS. 1 and 13) and recognition step U (see FIG. 12) simultaneously performed by mutually independent imager 9 and holder 10. This will be referred to as a moving and recognition step B.

Holder 10 holds piece 7 and thus moves from piece forming position 26 to the prescribed position 2. Imager 9 continues holding and recognition step A and recognizes position 2 until piece 7 is set at position 2. Cutter 8 and loader 24 feed adhesive tape 4 to be subsequently cut. As is apparent from FIG. 4, conventional moving steps T and V are simultaneously performed and as a result a reduced operation time is achieved.

FIG. 5 shows that conventional supplying step W (see FIG. 14) and recognition step U recognizing position 2 at which piece 7 is subsequently set are simultaneously performed by mutually independent holder 10 and imager 9. This will be referred to as a supplying and recognition step C. The FIGS. 3-5 method reduces the conventional five steps (S-W) to the three steps (A-C) of the present embodiment. More specifically, holder 10 can set piece 7 rapidly and with high precision at position 2 recognized by imager 9. At this point of time, the step of pre-pressing and fixing for an initial piece 7 completes. Imager 9 moves to a position over a subsequent, prescribed position 2 and recognizes position 2 rapidly and with high precision.

Thus in the present embodiment pre-press and fix unit 51 can perform three, pre-pressing and fixing steps (A-C) contributing a significantly shorter period of time of operation than conventional, corresponding step.

Then substrate 1 moves along rail 21 from pre-press and fix unit 51 to main press and fix unit 52, which is provided with presser and fixer 11 required to have an ability to exert a larger load on piece 7 than holder 10. Although not shown, main press and fix unit 52 is provided with a pressing and fixing platform at a rear surface of substrate 1 opposite position 2, as well as platform 25.

Furthermore, the pre-press and fix unit 51 platform 25 and the pressing and fixing platform are provided with a heater (not shown) acting to stick (or supply and set, and press and fix) piece 7 on substrate 1. Note that piece 7 (or double sided adhesive film 5) has a resin component, which further helps to stick piece 7 on substrate 1. Note that the heater may not be provided to platform 25 and the pressing and fixing platform and instead be provided to both or one of the pre-press and fix unit 51 holder 10 and presser and fixer 11.

Furthermore, presser and fixer 11 is provided for example with a loader of a pneumatic cylinder, a fluid pressure cylinder or the like (not shown) small in frictional resistance, a controller controlling the loader, and an electro-pneumatic regulator (not shown) to exert load on piece 7.

Such loader and controller can press against and thus fix on presser and fixer 11 only a single one of a plurality of pieces 7 placed on substrate 1 or more than one of the pieces on the substrate simultaneously. Furthermore, presser and fixer 11 may have a tip exchangeable as well as a tip jig (not shown) of holder 10. Desirably the tip has silicone rubber or fluororesin rubber or similar highly heat resistant material (not shown) attached thereto.

Then substrate 1 having undergone the main pressing and fixing step performed by main press and fix unit 52 is transported along rail 21 to peel off unit 53.

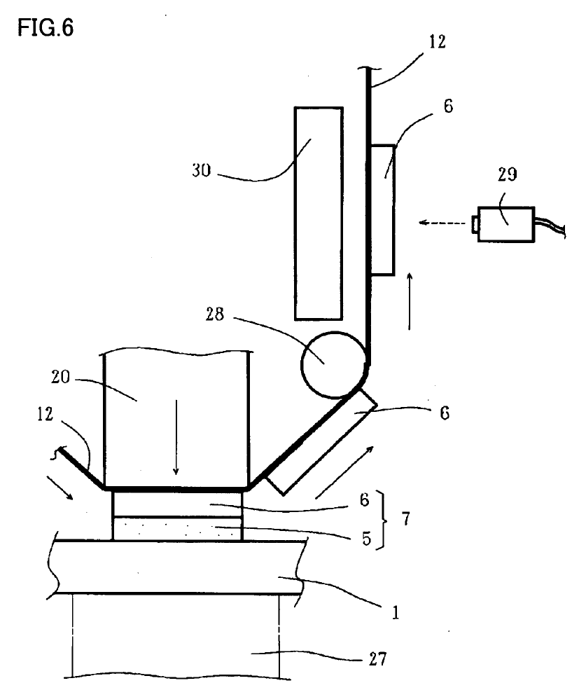

Reference will now be made to FIGS. 1-5 and in addition FIG. 6 to describe peel off unit 53 of the present embodiment. FIG. 6 is an enlarged, schematic side view of peel off unit 53 shown in FIG. 1.

Peel off unit 53 is provided with peel off film remover 13 provided with peel off film removing adhesive tape 12 and presser 20 and in addition thereto a peel off platform 27, a take up roller 28, a color sensor 29, and a detection board 30.

Peel off platform 27 bears substrate 1 with the prescribed position 2 facing upward. Take up roller 28 operates to take up the adhesive tape. Detector (or color sensor) 29 operates to recognize the peel off film. Detection board 30 is arranged opposite color sensor 29 with adhesive tape 12 posed therebetween.

Furthermore, the pre-press and fix unit 51 platform 25 and the main press and fix unit 52 pressing and fixing platform are provided with a heater further helping to stick the resin component of double sided adhesive film 5 on substrate 1. Furthermore to efficiently remove peel off film 6 from double sided adhesive film 5, a cooler (not shown) is provided for example having a piezoelectric element, a Peltier device or any similar element incorporated therein. The cooler cools a portion generating heat, i.e., for example piece 7 on substrate 1, in the step of peeling off. The cooler for example employs a heat sink and/or an air cooling fan and a detector to control temperature to be reduced to cool the heat generating portion in accordance with the resin characteristic(s) of double sided adhesive film 5 of piece 7.

Note that the aforementioned cooler may alternatively be of an air cooling system, which can reduce the cooler's cost. In the air cooling system, peel off platform 27 is provided with an air path (not shown) for circulated air. Furthermore, the air path may for example be provided with an ionizer (not shown) to reduce the amount of circulated air used. Furthermore, as the air cooling system a self cooling system, e.g., the colder system may be adopted. Note that the cooler or similar cooling system may not be provided at peel off platform 27 and instead be provided in peel off film remover 13 at presser 20.

Furthermore, presser 20 presses the entirety of piece 7 via adhesive tape 12, as shown in FIG. 6. Desirably, presser 20 has a tip of material or processed to be an elastic fluororesin member (not shown) or the like, for example. It should be noted, however, that it is not limited to fluororesin and may be of any elastic material. This can prevent piece 7 from receiving excessive pressure and double sided adhesive film 5 from having a surface with resin glue produced. Furthermore, it also allows uniform pressure to be exerted on piece 7 to press the piece.

Take up roller 28 is linked to an adhesive tape supplier (not shown) tensioning adhesive tape 12 with prescribed tension and loosening the tape. The tape supplier is provided with a pair of reels. One reel is a feed reel (not shown) arranged leftward of presser 20 to feed adhesive tape 12 toward piece 7 stuck on substrate 1. The other reel is a take up reel arranged rightward of presser 20 to take up adhesive tape 12 having peel off film 6 adhering thereto that has been removed from double sided adhesive film 5. The feed reel and the take up reel each have adhesive tape 12 wound therearound.

Color sensor 29 (or a detector) is adopted to overcome a disadvantage of conventional detectors. The conventional disadvantage is that peel off film 6 cannot be detected and substrate 1 with peel off film 6 still remaining at the prescribed position 2 is transported to the subsequent, bonding unit 54. This disadvantage is caused because piece 7 corresponding to substrate 1 of matrix type in recent years is significantly reduced in size and accordingly, peel off film 6 and adhesive tape 12 are also significantly reduced in size.

When the above issue is considered, using the aforementioned color sensor 29 entails coloring peel off film 6, transparent or opaque, to be detected, and also coloring adhesive tape 12 with a color different than peel off film 6. This can help color sensor 29 to recognize peel off film 6 adhering on adhesive tape 12. Furthermore to ensure that color sensor 29 detects peel off film 6 adhering on adhesive tape 12, desirably the color of peel off film 6 and that of adhesive tape 12 provide high contrast.

Furthermore, as shown in FIG. 6, color sensor 29 faces via adhesive tape 12 detection board 30 colored with a color different than peel off film 6. Detection board 30 is provided to further ensure that peel off film 6 is detected by color sensor 29.

Then substrate 1 with only double sided adhesive film 5 remaining thereon is transported by peel off unit 53 to bonding unit 54 along rail 21.

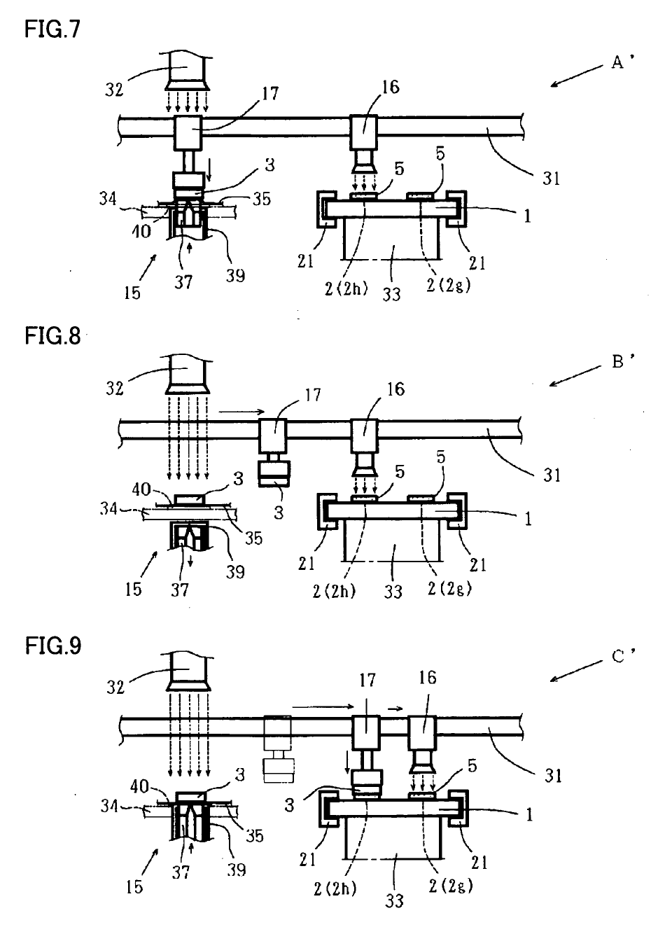

Reference will now be made to FIGS. 1 and 2 and in addition FIGS. 7-9 to describe bonding unit 54 of the present embodiment. Note that FIGS. 7-9 show in steps a bonding step performed by bonding unit 54 shown in FIG. 1.

As shown in FIGS. 1 and 7-9, bonding unit 54, as well as pre-press and fix unit 51, includes a chip bearing wafer table 14, a chip projector 15, a substrate recognizing imager 16, a chip holder 17, a rail 31 allowing imager 16 and holder 17 to move therealong, a chip recognizing imager 32, and a chip supplying and setting platform 33.

Wafer table 14 is movable in forward and backward, and rightward and leftward directions, as indicated in FIG. 1 by arrows. Furthermore, wafer table 14 is provided with an expander 34 fixing semiconductor chip 3 thereto with an adhesive fixing tape 35 to form a wafer plate 40. Wafer plate 40 is placed on wafer table 14.

Note that chip projector 15 penetrates expander 34 and wafer plate 40 to push a plurality of semiconductor chips 3 upward. Furthermore, when wafer plate 40 has semiconductor chip 3 remove therefrom, wafer plate 40 is ejected external to die bonding apparatus 50.

Thereafter, wafer plate 40 having accommodated semiconductor chip 3 moves from the position of a cassette elevator 36 shown in FIG. 1 at a right hand to that of expander 34 located in the figure at a left hand.

Furthermore, cassette elevator 36 accommodates a magazine cassette (not shown) in the form of a slit. The magazine cassette in the form of the slit bears a plurality of mutually spaced and vertically arranged wafer plates 40 having accommodated semiconductor chip 3. The magazine cassette is as a whole adapted to be vertically movable and can move independently wafer plates 40 accommodated in the magazine cassette toward a position over expander 34. Furthermore when wafer plate 40 is ejected from a magazine cassette, the empty magazine cassette is ejected from cassette elevator 36 to outside die bonding apparatus 50. Thereafter a magazine cassette having accommodated a required plurality of wafer plates 40 is introduced into die bonding apparatus 50 and placed at cassette elevator 36.

Chip projector 15 employs a projection member 37 shown in FIG. 7 to cause a plurality of semiconductor chips 3 on expander 34 to project upward. Note that after projection member 37 causes horizontal semiconductor chip 3 to project, the bonding unit 54 holder 17 holds semiconductor chip 3, as shown in FIG. 7.

Herein, projection member 37 has a portion in a vicinity of the tip in a cross, as shown in FIGS. 7-9. Alternatively, the portion may be in the form of an integrated triangle, quadrangle or circle.

In the present embodiment for example when chip projector 15 causes semiconductor chip 3 to project, initially wafer table 14 moves to a chip projection position 38 of chip projector 15. Note that on wafer table 14 semiconductor chip 3 is fixed to adhesive fixing tape 35.

Furthermore, as shown in FIG. 7, chip projector 15 accommodates a chip supporting platform 39. When chip projector 15 causes semiconductor chip 3 to project, platform 39 supports semiconductor chip 3 at position 38 (or a contact position) via adhesive fixing tape 35. Semiconductor conductor chip 3 is thus held by platform 39 horizontally.

Furthermore, platform 39 accommodates projection member 37. Projection member 37 pushes semiconductor chip 3 on the rear surface via adhesive fixing tape 35 upward. Projection member 37 then ascends to a position allowing semiconductor chip 3 to be passed to holder 17, and semiconductor chip 3 and adhesive fixing tape 35 partially peel off. In other words, semiconductor chip 3 partially sticks to adhesive fixing tape 35.

Then, semiconductor chip 3 is completely peeled off adhesive fixing tape 35 by holder 17. Then, as shown in FIG. 8, semiconductor chip 3 held by holder 17 moves along rail 31. Then, as shown in FIG. 9, semiconductor chip 3 is set by holder 17 on substrate 1 at the prescribed position 2 with double sided adhesive film 5 posed therebetween.

Furthermore, holder 17 presses semiconductor chip 3 against substrate 1, with double sided adhesive film 5 posed therebetween, with higher precision than the aforementioned pre-press and fix unit 51 holder 10.

Furthermore, similarly as has been described for pre-press and fix unit 51, substrate recognizing imager 16 and chip holder 17 are provided to independently move along the same rail 31.

Furthermore, as shown in FIGS. 1 and 7-9, rails 31 and 21 are vertically spaced so that substantially in orthogonal direction, imager 16 and holder 17 can move along rail 31 without colliding with rail 21. Imager 16 and holder 17 simultaneously perform three steps (A′-C′) performed by bonding unit 54 described later.

Thus holder 17 can move along rail 31 between position 38 at which chip projector 15 causes semiconductor chip 3 to project and the prescribed position 2 on substrate 1, as shown in FIGS. 7-9. Furthermore, imager 16 can move between position 2 and a position rightward of platform 33.

Thus bonding unit 54, as well as pre-press and fix unit 51, is provided with imager 16 and holder 17 independently. As such, imager 16 and holder 17 can simultaneously move along rail 31.

Chip recognizing imager 32 is provided separately from substrate recognizing imager 16. Furthermore, while substrate recognizing imager 16 can reciprocate, chip recognizing imager 32 is fixed at a position over chip projection position 38. It should be noted, however, that imager 32 may also be movable as well as imager 16. Imager 32 can continuously or intermittently recognize semiconductor chip 3 held by holder 17 and the chip's defect in external appearance, as shown in FIGS. 7-9.

Bonding unit 54 performs the three step (A′-C′) as will now be described hereinafter.

Initially FIG. 7 shows that mutually independently provided substrate recognizing imager 16 and chip holder 17 are employed to simultaneously perform a holding step and a recognition step, respectively. Note that this will be referred to as a holding and recognition step A′. In this step, holder 17 holds semiconductor chip 3 projected from chip projection position 38 of chip projector 15. Imager 16 moves independently of the holding step performed by holder 17 and employs a CCD camera or the like to recognize the prescribed position 2 on substrate 1.

While imager 16 thus operates, imager 32 implemented for example by a CCD camera or the like can separately monitor and recognize how semiconductor chip 3 is held and how the chip is determined between pass and fail.

FIG. 8 shows that mutually independent imager 16 and holder 17 are employed to simultaneously perform a moving step and a recognition step, respectively. Note that this will be referred to as a moving and recognition step B′. In this step, holder 17 holding semiconductor chip 3 moves from chip projection position 38 to the prescribed position 2.

Imager 16 continues to recognize position 2 until semiconductor chip 3 is set at position 2 with double sided adhesive film 5 posed therebetween. Chip projector 15 moves to under semiconductor chip 3 (a conforming chip) to be subsequently projected. Furthermore, projection member 37 enters platform 39 and also waits below expander 34 and wafer plate 40.

As is apparent from FIG. 8, the present embodiment's die bonding apparatus 50 can simultaneously perform moving steps T and V performed by pre-press and fix unit 51 as conventional. The pre-pressing and fixing step can thus be performed in an efficiently reduced period of time.

FIG. 9 shows that mutually independent holder 17 and imager 16 are employed to simultaneously perform a supplying step and a subsequent recognition step, respectively. Note that this will be referred to as a supplying and recognition step C′.

In the above described method bonding unit 54 performs only three steps (A′-C′), and holder 17 can set semiconductor chip 3 rapidly and with high precision at the prescribed position 2 recognized by imager 16.

At this point in time an initial semiconductor chip 3 has been set at position 2 and will completely be bonded, while imager 16 moves to over a subsequent prescribed position 2 and recognizes the position, and the chip projector 15 projection member 37 is ready to project semiconductor chip 3 (a conforming chip) recognized by imager 32.

As shown in FIGS. 7-9, initially semiconductor chip 3 is set at the prescribed position 2h and then semiconductor chip 3 is set at the prescribed position 2g. Thereafter when semiconductor chip 3 is set at positions 2g and 2h, holder 17 and imager 16 moves along rail 21 in a direction indicated in FIGS. 7-9 by an arrow to a position over the prescribed positions 2e and 2f at which a subsequent semiconductor chip 3 is set. Then holder 17 and imager 16 similarly arrives at over the prescribed positions 2c and 2d. Finally, holder 17 and imager 16 arrives at over the prescribed positions 2a and 2b.

As has been described previously, the three steps (A′-C′) in the bonding step shown in FIGS. 7-9 are repeated to mount semiconductor chip 3 on substrate 1 at eight prescribed positions 2 with double sided adhesive film 5 posed therebetween.

Thus the three steps (A′-C′) performed by bonding unit 54, as well as the three steps (A-C) performed by pre-press and fix unit 51, can be performed in a shorter period of time than the conventional five steps (S-W).

Then after bonding unit 54 has completed the bonding step, substrate 1 is transported along rail 21 to after-press unit 55.

After-press unit 55, as well as main press and fix unit 52, is provided with presser and fixer 19. Presser and fixer 19 is required to have an ability to exert larger load than holder 17. Furthermore, presser and fixer 19 can press semiconductor chip 3 against substrate 1 faster and with higher precision than presser and fixer 11 of main press and fix unit 52. Furthermore, after-press unit 55 is miniaturized and less costly. Furthermore, although not shown, as well as platform 33, a pressing (pressing and fixing) platform is provided at a side of substrate 1 opposite position 2.

The pressing platform and the bonding unit 54 platform 33 are provided with a heater (not shown). This heater's heating effect is utilized to mount (or set, and press and fix) semiconductor chip 3 on substrate 1. This enables the double sided adhesive film 5 resin component to further help to stick semiconductor chip 3 on substrate 1. Note that the heater may not be provided at the platforms and instead be provided to the after-press unit 55 presser and fixer 19 and the bonding unit 54 holder 17.

Furthermore, presser and fixer 19 is provided for example with a loader of a pneumatic cylinder, a fluid pressure cylinder or the like (not shown) small in frictional resistance, a controller controlling the loader, and an electro-pneumatic regulator (not shown). The loader and the controller employ the aforementioned each unit to mount a single semiconductor chip 3 on substrate 1 at the prescribed position 2 or a plurality of rows of semiconductor chips 3 on substrate 1 at position 2 simultaneously.

Furthermore, as shown in FIG. 1, to prevent semiconductor chip 3 from having a damaged surface, a chip protection film 18 is applied to cover the chip's surface to prevent presser and fixer 19 from contacting the chip's surface when presser and fixer 19 presses and thus mounts the chip on the substrate. Note that a protection film supplier (not shown) exerts prescribed tension to tension and loose protection film 18.

Furthermore, if as well as holder 17 presser and fixer 19 has an exchangeable tip, the tip may for example have a silicone rubber or fluororesin rubber or similar highly heat resistant material (not shown) attached thereto.

Furthermore, as presser and fixer 19 presses semiconductor chip 3 against substrate 1 with protection film 18 posed therebetween, desirably the presser and fixer 19 tip is formed of material or processed to be an appropriately elastic fluororesin member (not shown). Note that the tip may be formed of any material other than fluororesin that is equivalently elastic.

Thus presser and fixer 19 can exert appropriate pressure on semiconductor chip 3 directly or with protection film 18 posed therebetween. This can prevent excessive pressure otherwise exerted on semiconductor chip 3 and as a result producing resin glue on a surface of double sided adhesive film 5. Furthermore, the semiconductor chip 3 main surface and presser and fixer 19 can achieve satisfactory surface contact therebetween.

Finally, substrate 1 with semiconductor chip 3 mounted thereon by after-press unit 55 is transported along rail 21 to out-magazine unit 57 and housed therein within a magazine cassette. After semiconductor chip 3 is mounted on substrate 1 by after-press unit 55, for example a wire bonding step and a molding step or the like may successively be performed.

Note that while in the present embodiment adhesive tape 4 is formed of two layers, employing adhesive tape 4 formed of a single layer allows die bonding apparatus 50 to dispense with peel off unit 53. As such, die bonding apparatus 50 having only pre-press and fix unit 51 and main press and fix unit 52 or having units 51 and 52 integrated into a single unit, may be used.

Furthermore, die bonding apparatus 50 may not have after-press unit 55. Furthermore, after-press unit 55 may not be included in bonding unit 54. Furthermore, the die bonding apparatus 50 seven units 51-57 may be selectively used depending on adhesive tape 4 formed of a plurality of layers and the manner of substrate 1.

Furthermore, while the embodiment has been described in connection with die bonding apparatus 50 employed for substrate 1 that is to have semiconductor chip 3 mounted at the prescribed position 2, die bonding apparatus 50 may be used for example for a flip chip substrate that is to have a semiconductor chip mounted thereon via a bump (or a connection electrode). Furthermore, die bonding apparatus 50 may be used for a substrate in the form of a stack that is to have an initial semiconductor chip stuck on substrate 1 and a subsequent semiconductor chip stuck on the initial semiconductor chip.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A die bonding apparatus mounting an electronic component on a substrate at a prescribed position with a double sided adhesive film posed therebetween, comprising a pre-press and fix unit, a main press and fix unit, and a bonding unit, wherein:
said pre-press and fix unit includes a cutter cutting a double sided adhesive tape into a prescribed size, a first imager recognizing said prescribed position on said substrate, and a first holder setting said double sided adhesive film at said prescribed position;
said main press and fix unit includes a first presser and fixer pressing said double sided adhesive film against said substrate to fix said double sided adhesive film on said substrate at said prescribed position;
said bonding unit includes a second imager recognizing said prescribed position on said substrate, and a second holder setting said electronic component on said double sided adhesive film set on said substrate at said prescribed position; and
said pre-press and fix unit has said first imager and said first holder adapted to be movable mutually independently and simultaneously;
said bonding unit has said second imager and said second holder adapted to be movable mutually independently and simultaneously.

2. A die bonding apparatus mounting an electronic component on a substrate at a prescribed position with a double sided adhesive film posed therebetween, comprising a pre-press and fix unit, a main press and fix unit, a peel off unit, a bonding unit, and an after-press unit, wherein:
said pre-press and fix unit includes a cutter cutting into a prescribed size a double sided adhesive tape having a peel off film adhering thereto, a first imager recognizing said prescribed position on said substrate, and a first holder setting said double sided adhesive film at said prescribed position;
said main press and fix unit includes a first presser and fixer pressing said double sided adhesive film against said substrate via said peel off film to fix said double sided adhesive film on said substrate at said prescribed position;
said peel off unit includes a peel off film remover applying an adhesive tape on said peel off film and removing said peel off film from said double sided adhesive film to allow said double sided adhesive film alone to remain on said substrate;
said bonding unit includes a second imager recognizing said prescribed position on said substrate, and a second holder setting said electronic component on said double sided adhesive film set on said substrate at said prescribed position;
said after-press unit includes a second presser and fixer pressing against and fixing on said adhesive film said electronic component located at said prescribed position; and
said pre-press and fix unit has said first imager and said first holder adapted to be movable mutually independently and simultaneously;
said bonding unit has said second imager and said second holder adapted to be movable mutually independently and simultaneously.

3. The die bonding apparatus according to claim 2, wherein:
said pre-press and fix unit, said main press and fix unit, said peel off unit, said bonding unit and said after-press unit are integrated together; and
the die bonding apparatus moves said substrate through said pre-press and fix unit, followed by said main-press and fix unit, then said peel off unit, then said bonding unit, and then said after-press unit sequentially and continuously.
